(19) United States
(12) Patent Application Publication
(10) Pub. No.: US 2006/0207110 A1
(43) Pub. Date: Sep. 21, 2006

(54) Ceramic cutting knife

(75) Inventors: Yuuichi Nishigaki, Kyoto-shi (JP); Takanori Nishihara, Kyoto-shi (JP)

Correspondence Address: HOGAN & HARTSON L.L.P., 500 S. GRAND AVENUE, SUITE 1900, LOS ANGELES, CA, 90071-2611, US

(73) Assignee: KYOCERA CORPORATION

(21) Appl. No.: 11/368,365

(22) Filed: Mar. 2, 2006

(30) Foreign Application Priority Data
Mar. 3, 2005 (JP) 2005-059108

(51) Int. Cl. B26B 9/00

(52) U.S. Cl. 30/350

(57) ABSTRACT

A ceramic cutting knife comprise a handle part and a ceramic blade part fixed to the handle part. The blade part has a cutting edge; a back edge, the back of which is the cutting edge; and an arcuate tip edge formed at a tip portion of the blade part and being continuous with the cutting edge and having a predetermined radius of curvature. At least one side surface of the blade part comprise a large blade surface tilted from the large blade surface to the cutting edge, and a small blade surface tilted from the large blade surface to the cutting edge at a larger angle than the large blade surface. The small blade surface extends at least from the cutting edge through the arcuate tip edge to a location at which an arc of the arcuate tip edge terminates. This enables to suppress the occurrence of broken blades at the cutting edge and the arcuate tip edge.

Priority is claimed to Japanese Patent Application No. 2005-59108 filed on Mar. 3, 2005, the disclosure of which is incorporated by reference in its entirety.

### BACKGROUND OF THE INVENTION

1. Field of the Invention

The present invention relates to a ceramic cutting knife such as a kitchen knife having a blade part made of ceramic.

2. Description of Related Art

Kitchen knives as a cutting knife of general and widespread use are mostly made of metal such as steel or stainless steel. For example, a kitchen knife made of steel is easy to manufacture and inexpensive. However, the original excellent cutting quality is apt to deteriorate because its cutting edge wears in use. Moreover, because it is apt to rust, the cutting quality is likely to worsen. This requires frequent grinding. After each use, it is necessary to wipe off water and apply rust prevention. Additionally, the iron component of the kitchen knife is apt to soak into food, leaving a metal smell and spoiling the taste of dish.

On the other hand, a kitchen knife made of stainless steel has a lower hardness than steel, and hence its cutting edge is apt to wear, and the cutting quality will deteriorate in a short time. In the meantime, a kitchen knife made of special stainless steel alloy containing molybdenum, tungsten, or the like is commercially available. This kitchen knife is hard to rust and has a high hardness, but poor durability of cutting quality for its price.

As above described, in the conventional kitchen knives made of metal, the wearing and rusting of the cutting edge causes premature deterioration of cutting quality, necessitating frequent grinding. Moreover, a metal smell is apt to soak into food. There is also the problem that these kitchen knives are weak in acid and alkali, and are apt to corrode.

To overcome the foregoing problems encountered in the kitchen knives made of metal, a kitchen knife made of ceramic represented by zirconia ceramics comes in practice (see Japanese Unexamined Patent Publication Nos. 58-71095, and 62-275057).

FIG. 7 is a schematic side view illustrating a conventional ceramic kitchen knife as described in the above publications. FIG. 8 is a schematic sectional view illustrating a blade part in FIG. 7.

Referring to FIGS. 7 and 8, a conventional ceramic kitchen knife 11 comprise a handle part 12, and a blade part 13 fixed to the handle part 12.

The blade part 13 has a cutting edge 14; a narrow back edge 15, the back of which is the cutting edge 14; and an arcuate tip edge 17 that is formed at the tip portion of the blade part 13 and has a predetermined radius of curvature. The side surface of the blade part 13 has a large blade surface 16 tilted from the back edge 15 to the cutting edge 14. The large blade surface 16 has a rough surface part 18 being roughened and extending from the cutting edge 14 to the arcuate tip edge 17 on the surface of a blade end of the large blade surface 16.

A metal kitchen knife is tapered off to a tip, in order to retain the cutting quality even at the tip of its blade part. On the contrary, if a ceramic kitchen knife is tapered off to a tip, it is likely to cause a broken blade and a crack. For this reason, there is proposed one having a tip in the form of an arcuate, namely having the arcuate tip edge 17, as shown in FIG. 7.

However, the ceramic kitchen knife 11 has a lower toughness than the metal kitchen knife, so that not only the arcuate tip edge 17 but also the cutting edge 14 is likely to cause a broken blade. By the presence of the arcuate tip edge 17, it is unable to make full use of the function inherent in a kitchen knife, such as ornamental cuts and invisible cuts, which are attainable with use of the point of the blade part 13. This hinders handiness or usefulness.

### SUMMARY OF THE INVENTION

The present invention provides a ceramic cutting knife that can suppress the occurrence of broken blades of a cutting edge and an arcuate tip edge, without hindering the function and usefulness inherent in a kitchen knife.

A ceramic cutting knife according to the present invention comprise a handle part and a ceramic blade part fixed to the handle part. The blade part has a cutting edge, a back edge, the back of which is the cutting edge, and an arcuate tip edge formed at a tip portion of the blade part and being continuous with the cutting edge and having a predetermined radius of curvature. At least one side surface of the blade part comprise a large blade surface tilted from the back edge to the cutting edge, and a small blade surface tilted from the large blade surface to the cutting edge at a larger angle than the large blade surface. The small blade surface extends at least from the cutting edge through the arcuate tip edge to a location at which an arc of the arcuate tip edge terminates. Preferably, the large blade surface has an angle of 0.1 to 15°, and the small blade surface has an angle of 20 to 55°.

In the ceramic cutting knife of the invention, the blade part comprise the large blade surface tilted from the back edge to the cutting edge, and the small blade surface tilted from the large blade surface to the cutting edge at a larger angle than the large blade surface. This allows for a large cutting angle of the cutting edge, permitting considerable suppression of a broken blade at the cutting edge. Moreover, the small blade surface is formed so as to extend at least from the cutting edge through the arcuate tip edge to a location at which an arc of the arcuate tip edge terminates. This allows for a large cutting angle of the arcuate tip edge, permitting considerable suppression of a broken blade at the arcuate tip edge. This also improves the cutting quality of the arcuate tip edge. As a result, the occurrence of broken blades at the cutting edge and the arcuate tip edge can be suppressed without hindering the function and usefulness inherent in a kitchen knife.

In particular, the cutting quality is satisfactory when the large blade surface has an angle of 0.1 to 15°, and the small blade surface has an angle of 20 to 55°.

Other objects and advantages of the present invention will become more apparent from the following detailed description of the present invention when taken in conjunction with the accompanying drawings.

### BRIEF DESCRIPTION OF THE DRAWINGS

FIG. 1 is a schematic side view illustrating a ceramic kitchen knife according to one preferred embodiment of the present invention;

FIG. 2 is a schematic sectional view illustrating a blade part in FIG. 1;

FIG. 3 is an enlarged schematic side view illustrating the vicinity of an arcuate tip edge in FIG. 1;

FIG. 4 is a schematic explanatory diagram for the purpose of explaining the angles of a large blade surface and a small blade surface;

FIG. 5 is a schematic sectional view illustrating a blade part of a ceramic kitchen knife according to other preferred embodiment of the present invention;

FIG. 6 is a schematic explanatory diagram for the purpose of explaining an impact resistance test carried out in examples;

FIG. 7 is a schematic side view illustrating a conventional ceramic kitchen knife; and

FIG. 8 is a schematic sectional view illustrating a blade part in FIG. 7.

### DETAILED DESCRIPTION OF PREFERRED EMBODIMENTS

<Ceramic Cutting Knife>

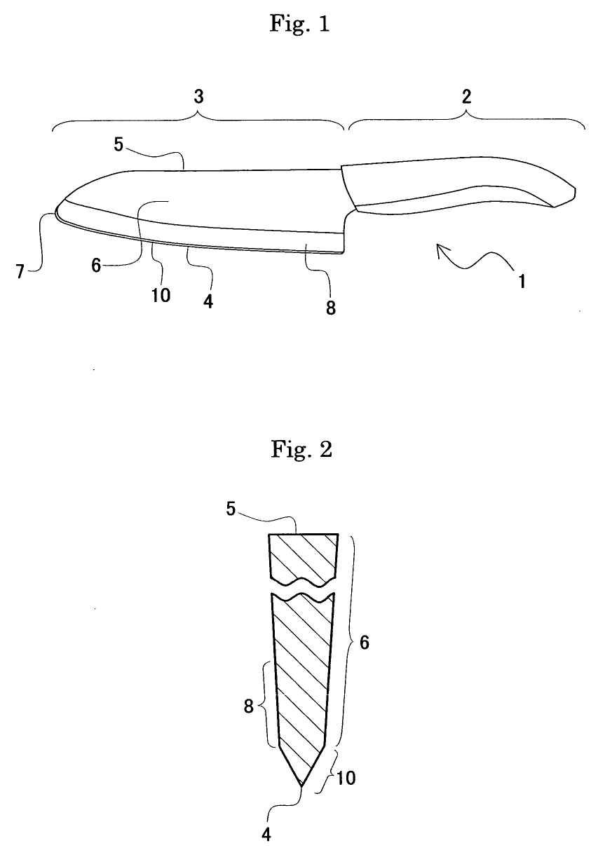

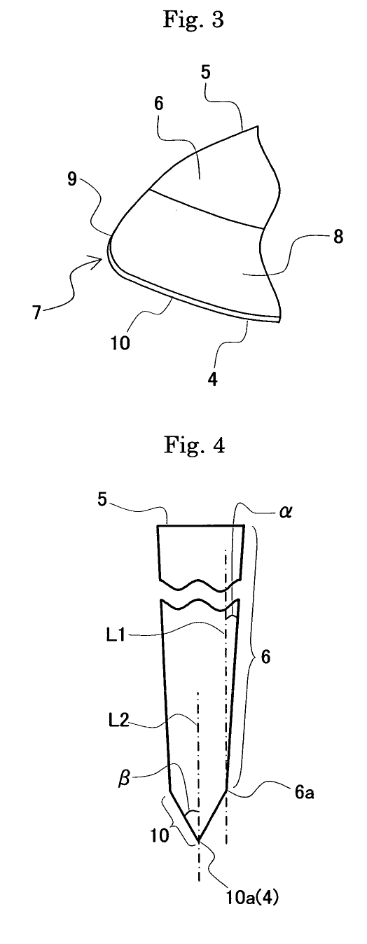

A ceramic cutting knife of the present invention will be described in detail with reference to the accompanying drawings, exemplifying a case where the ceramic cutting knife is applied to a ceramic kitchen knife. FIG. 1 is a schematic side view illustrating a ceramic kitchen knife according to one preferred embodiment of the present invention. FIG. 2 is a schematic sectional view illustrating a blade part in FIG. 1. FIG. 3 is an enlarged schematic side view illustrating the vicinity of an arcuate tip edge in FIG. 1.

Referring to FIG. 1, a ceramic kitchen knife 1 comprise a handle part 2, and a blade part 3 that is made of ceramic and fixed to the handle part 2. The blade part 3 has a cutting edge 4, a narrow back edge 5, the back of which is the cutting edge 4, and an arcuate tip edge 7 that is formed at the tip portion of the blade part 3 and continuous with the cutting edge 4 and has a predetermined radius of curvature.

Preferably, the back edge 5 is narrow, approximately 5 mm at most.

Although the radius of curvature of the arcuate tip edge 7 is not particularly limited, approximately 2 to 4 mm are suitable for suppressing a broken blade at the arcuate tip edge 7.

On both surfaces of the blade part 3, a large blade surface 6 and a small blade surface 10 are continuously formed. The large blade surface 6 is tilted from the back edge 5 to the cutting edge 4, and the small blade surface 10 is tilted from the large blade surface 6 to the cutting edge 4 at a larger angle than the large blade surface 6, as shown in FIG. 2. This allows for a large cutting angle of the cutting edge 4, permitting considerable suppression of a broken blade at the cutting edge 4.

Referring to FIG. 3, the small blade surface 10 is formed so as to extend from the cutting edge 4 through the arcuate tip edge 7 to a location 9 at which an arc of the arcuate tip edge 7 terminates. This allows for a large cutting angle of the arcuate tip edge 7, permitting considerable suppression of a broken blade at the arcuate tip edge 7. This also improves the cutting quality of the arcuate tip edge 7. Hence, the arcuate tip edge 7, namely the tip portion of the blade part 3 of the kitchen knife 1 can be used as a cutting edge, making the kitchen knife 1 more useful. For example, when a user is cutting a cooking material by the tip of the kitchen knife 1, it is easy for the user to feel which part of the cooking material is actually being cut, thereby facilitating and ensuring fine technique such as ornamental cuts. This eliminates the possibility of impairment of the function and usefulness inherent in the kitchen knife 1.

The small blade surface 10 may be formed so as to extend at least from the cutting edge 4 through the arcuate tip edge 7 to the location 9 at which an arc of the arcuate tip edge 7 terminates. In other words, the small blade surface 10 may extend beyond the location 9.

Preferably, the small blade surface 10 extends for a range of not more than 3.0 mm from the cutting edge 4. If the small blade surface 10 is formed beyond the above-mentioned range, the strength of the blade part 3 might be considerably lowered to cause frequent broken blades.

Preferably, the large blade surface 6 has a rough surface part 8 being roughened and extending from the cutting edge 4 to the arcuate tip edge 7 on the surface of a blade end of the large blade surface 6, as shown in FIG. 1. This makes it possible to cut an object without slipping.

Preferably, the angle α of the large blade surface 6 is set to 0.1 to 15°, particularly 1 to 5°. When the angle α is smaller than 0.1°, the strength of the blade part 3 might be considerably lowered to cause frequent broken blades and cracks. When the angle α is larger than 15°, the load exerted when cutting a cooking material or the like will be increased to deteriorate cutting quality.

Preferably, the angle β of the small blade surface 10 is set to 20 to 55°, particularly 30 to 45°. When the angle β is smaller than 10°, the strengths of the cutting edge 4 and the arcuate tip edge 7 might be considerably lowered to cause frequent broken blades. When the angle β is larger than 55°, the cutting quality is lowered considerably.

Satisfactory cutting quality is attainable by setting the angles of the large blade surface 6 and the small blade surface 10 as above described. As used herein, the angle α of the large blade surface 6 means an angle formed by the large blade surface 6 and a vertical line L1 passing through a cutting edge terminal portion 6a of the large blade surface 6, when the cutting edge 4 is placed perpendicularly to the level plane, as shown in FIG. 4. The angle β of the small blade surface 10 means an angle formed by the small blade surface 10 and a vertical line L2 passing through a cutting edge terminal portion 10a (the cutting edge 4) of the small blade surface 10, when the cutting edge 4 is placed perpendicularly to the level plane, as shown in FIG. 4.

The above-mentioned blade part 3 can be made of zirconia ceramic, alumina zirconia, silicon nitride or the like, more preferably zirconia ceramic. This can make a cutting knife less easily broken .

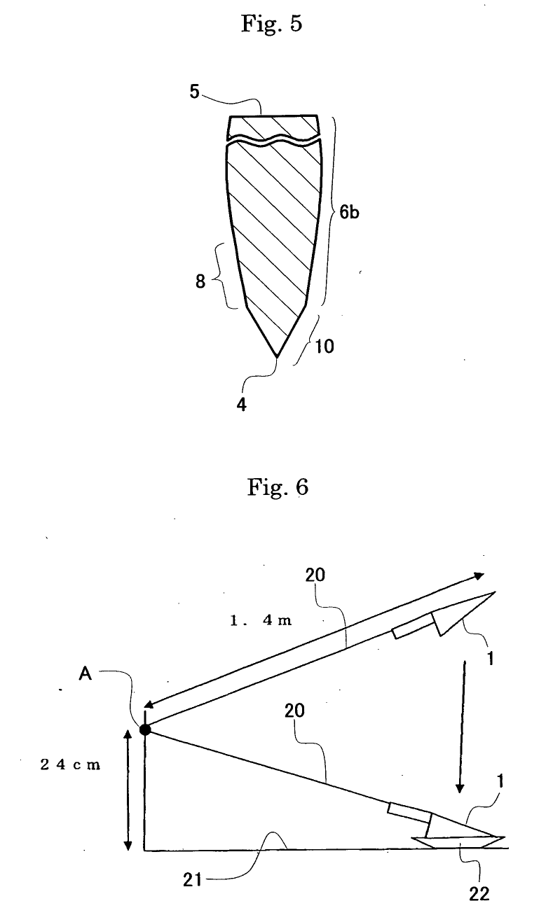

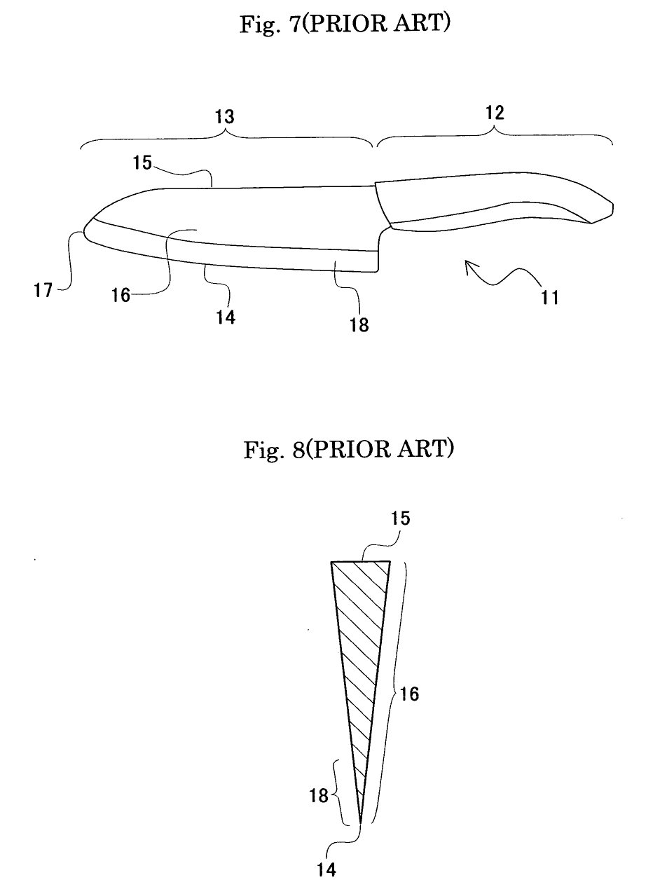

Although in the foregoing preferred embodiment the large blade surface is formed by a flat surface, as shown in FIG. 2, the large blade surface of the present invention may be formed by a curved surface. FIG. 5 is a schematic sectional view illustrating a blade part of a ceramic kitchen knife according to other preferred embodiment of the present invention. In FIG. 5, the same reference numerals have been retained for parts similar to or identical with that in the constructions of FIGS. 1 to 4, and the descriptions of these parts are left out of the following.

Referring to FIG. 5, a large blade surface 6b is formed by a curved surface. This can improve the strength of the blade part, and prevent a cut cooking material and the like from attaching to the blade part. Preferably, the curved surface has a radius of curvature (R) of approximately 400 to 800 mm.

<Manufacturing Method>

A method for manufacturing the ceramic kitchen knife 1 will next be described by exemplifying a kitchen knife made of zirconia ceramic. First, to zirconia powder containing 1.5 to 3 mol % of yttria powder, 2 to 10 weight % of acryl or wax or polyethylene glycol (PEG) binder is added to prepare granule having a mean particle diameter of 10 to 150 μm.

As shown in FIGS. 1 to 3, the granule is then formed in a predetermined shape with a mold at a forming pressure of 700 to 2000 Kg/cm², followed by firing at 1300 to 1500° C., thereby obtaining a zirconia sintered body.

Thereafter, putting an edge is carried out with a known method, and a large blade surface 6, a small blade surface 10, and a cutting edge 4 are formed. At this time, the small blade surface 10 can be formed at an arcuate tip edge 7 by allowing the small blade surface 10 to be continuously formed at a cutting edge portion, and making a turn about a terminal portion at the moment the terminal portion is subjected to processing. The blade part 3 so obtained is fixed to a predetermined handle part 2, resulting in the zirconia ceramic kitchen knife 1.

As a method for forming a forming body, any known forming method other than the above-mentioned method, such as casting method, plastic forming method (e.g., injection forming method), rubber press method, or hot press method may be employed. Alternatively, the obtained zirconia sintered body may be sintered at 1300 to 1500° C., and then held at 1500 to 2500 Kg/cm² for 2 to 5 hours, which is so-called HIP method.

In an alternative, to form the rough surface part 8 on the large blade surface 6, the surface of a predetermined cutting edge portion of the large blade surface 6 may be roughed by etching, polishing, or the like.

Although the foregoing preferred embodiment has discussed the case where the large blade surface and the small blade surface are formed on both side surfaces of the blade part, the present invention is not limited to this. Specifically, the large blade surface and the small blade surface may be formed at least one side surface of the blade part.

Although the description has been made of the case where the ceramic cutting knife of the present invention is applied to the ceramic kitchen knife, the ceramic cutting knife is likewise applicable to any cutting knife other than the ceramic kitchen knife, for example, a variety of knives.

Examples of the present invention will be described below. It is understood, however, that the examples are for the purpose of illustration and the invention is not to be regarded as limited to any of the specific materials or condition therein.

### EXAMPLES

Setting the angle of a large blade surface to 0.5 to 10°, and the angle of a small blade surface to 25 to 50°, a kitchen knife made of zirconia ceramic was manufactured by the above-mentioned manufacturing method (Samples Nos. 1 to 12 in Table 1). Sample No. 13 (a conventional one) was manufactured in the same manner as in Samples Nos. 1 to 12, except that no small blade surface was formed.

Next, with regard to the obtained kitchen knives (Samples Nos. 1 to 13 in Table 1), an impact resistance test for their cutting edges was conducted. FIG. 6 shows the method of the impact resistance test. Specifically, with one end of a bar 20 having a length of 1.4 m as a rotation center A, the bar 20 was set at a position, 24 cm high from a platform 21, such that it can be smoothly turned up and down. Subsequently, the above-mentioned kitchen knife 1 was fixed to the other end of the bar 20, and the kitchen knife 1 was then raised to a position, 50 cm high from the platform 21. A porcelain dish 22 was placed on the platform 21, against which the kitchen knife 1 dropped and impacted.

More specifically, the porcelain dish 22 was placed at a position against which the central portion of the cutting edge of the blade part dropped and impacted. Besides this, the porcelain dish 22 was placed at a position against which the arcuate tip edge of the blade part dropped and impacted.

Thereafter, the hand was released gently to allow the kitchen knife 1 to drop and impact under its own weight against the porcelain dish 22. The above-mentioned impact resistance test was repeated 30 times. The state of the blade part (central portion of cutting edge, arcuate tip edge) after test was evaluated according to the following criteria for evaluation: the symbol “∘” indicating no change (the occurrence of a broken blade smaller than 0.3 mm); the symbol “Δ” indicating the occurrence of a broken blade of 0.3 to 1.0 mm; and the symbol “X” indicating the occurrence of a broken blade larger than 1.0 mm.

In addition, the cutting qualities of these kitchen knives were evaluated by monitoring. Ten housekeepers were asked to monitor. Specifically, these kitchen knives were actually used at house for 30 days to evaluate the cutting quality. The obtained were evaluated according to the following criteria for evaluation: the symbol “∘” indicating that nine or more monitors judged excellent cutting quality; the symbol “Δ” indicating that five to eight monitors judged excellent cutting quality; and symbol “X” indicating that four or less monitors judged excellent cutting quality.

Table 1 shows the results of the impact resistance and the cutting quality test. as used herein, the symbol “Δ” in the results of the impact resistance test and the cutting quality test falls under the range free from any practical problem.

TABLE 1

| | | Angle | Impact resistance test | | |
|---|---|---|---|---|---|
| | Angle of large | of small | Central | Arcuate | Cutting |
| Sample | blade surface | blade surface | portion of | tip | quality |
| No.¹⁾ | (°) | (°) | cutting edge | edge | test |
| 1 | 0.5 | 35 | Δ | Δ | ◯ |
| 2 | 1 | 35 | ◯ | ◯ | ◯ |
| 3 | 2 | 35 | ◯ | ◯ | ◯ |
| 4 | 3 | 25 | Δ | Δ | ◯ |
| 5 | 3 | 30 | ◯ | ◯ | ◯ |
| 6 | 3 | 35 | ◯ | ◯ | ◯ |
| 7 | 3 | 45 | ◯ | ◯ | ◯ |
| 8 | 3 | 50 | ◯ | ◯ | Δ |
| 9 | 4 | 35 | ◯ | ◯ | ◯ |
| 10 | 5 | 35 | ◯ | ◯ | ◯ |
| 11 | 7 | 35 | ◯ | ◯ | Δ |
| 12 | 10 | 35 | ◯ | ◯ | Δ |
| *13 | 3 | — | X | X | ◯ |

¹⁾Sample marked ‘*’ is out of the scope of the present invention.

It will be noted from Table 1 that Samples Nos. 1 to 12 having predetermined large blade surface and small blade surface are superior to Sample No. 13 having no small blade surface, in terms of impact resistance and cutting quality. In particular, good results were obtained from Samples Nos. 2, 3, 5 to 7, 9, and 10, the large blade surface of which has an angle of 1 to 5°, and the small blade surface has an angle of 30 to 45°.

It is further understood by those skilled in the art that the foregoing description is a preferred embodiment of the disclosed knife and that various changes and modifications may be made in the invention without departing from the spirit and scope thereof.

What is claimed is:

1. A ceramic cutting knife comprising a handle part and a ceramic blade part fixed to the handle part, the blade part having a cutting edge; a back edge, the back of which is the cutting edge; and an arcuate tip edge formed at a tip portion of the blade part and being continuous with the cutting edge and having a predetermined radius of curvature,
at least one side surface of the blade part comprising a large blade surface tilted from the back edge to the cutting edge, and a small blade surface tilted from the large blade surface to the cutting edge at a larger angle than the large blade surface, and
the small blade surface extending at least from the cutting edge through the arcuate tip edge to a location at which an arc of the arcuate tip edge terminates.

2. The ceramic cutting knife according to claim 1 wherein the small blade surface extends for a range of not more than 3.0 mm from the cutting edge.

3. The ceramic cutting knife according to claim 1 wherein the large blade surface includes a rough surface part being roughened and extending from the cutting edge to the arcuate tip edge on a surface of a blade end of the large blade surface.

4. The ceramic cutting knife according to claim 1 wherein the large blade surface has an angle of 0.1 to 1.5°, and the small blade surface has an angle of 20 to 55°.

5. The ceramic cutting knife according to claim 1 wherein the large blade surface has an angle of 1 to 5°, and the small blade surface has an angle of 30 to 45°.

6. The ceramic cutting knife according to claim 1 wherein the large blade surface and the small blade surface are formed on both side surfaces of the blade part.

7. The ceramic cutting knife according to claim 1 wherein the large blade surface is formed by a curved surface having a radius of curvature (R) of 400 to 800 mm.

8. The ceramic cutting knife according to claim 1 wherein the blade part is made of zirconia ceramic.
